(19) United States
(12) Patent Application Publication
(10) Pub. No.: US 2012/0166355 A1
(43) Pub. Date: Jun. 28, 2012

(54) MAINTENANCE OF MASTER DATA BY ANALYSIS OF OPERATIONAL DATA

(76) Inventors: Markus Biehler, Landau (DE); Jochen Steinbach, Bad Schoenborn (DE)

(21) Appl. No.: 12/976,959

(22) Filed: Dec. 22, 2010

(51) Int. Cl. G06Q 10/00

(52) U.S. Cl. 705/348

(57) ABSTRACT

First operational data produced during completion of a first instance of at least one of a first business activity and a second business activity of an organization can be accessed prior to execution of a second instance of the first business activity. The first and the second business activity can be modeled using master data having at least one master data attribute in common with the first business activity. The master data attribute can be derived based on at least the first operational data, and a second instance of the first business activity can be modeled using the derived master data attribute. Related systems, articles of manufacture, and computer-implemented methods are described.

### TECHNICAL FIELD

The subject matter described herein relates to maintaining master data in a current state, for example by analyzing operational data, in some implementations in real time.

### BACKGROUND

Various organizations make use of enterprise resource planning (ERP) software architectures to provide an integrated, computer-based system for management of internal and external resources, such as for example tangible assets, financial resources, materials, customer relationships, and human resources. In general, an ERP software architecture is designed to facilitate the flow of information between business functions inside the boundaries of the organization and manage the connections to outside service providers, stakeholders, and the like. Such architectures often include one or more centralized databases accessible by a core software platform that consolidates business operations, including but not limited to those provided by third party vendors, into a uniform and organization-wide system environment. The core software platform can reside on a centralized server or alternatively be distributed across modular hardware and software units that provide “services” and communicate on a local area network or over a network, such as for example the Internet, a wide area network, a local area network, or the like.

Keeping master data or other data relating to business processes and business process configurations up-to-date and consistent with the real conditions that these data are intended to represent can present a significant challenge in business systems, such as for example an ERP software architecture. Master data can represent one or more factors related to transactions and processes undertaken within an enterprise and can be characterized generally as persistent, non-transactional data to which business processes and/or business objects refer. Master data typically define one or more aspects of a business entity and can have fixed or infrequently varying values and/or structures across multiple instances of data objects in which they appear. In some examples, master data can describe items and interactions occurring between items involved in a transaction or a business process and can optionally include, without limitation, data pertaining to customers, products, employees, materials, suppliers, vendors, parts, policies and activities, and the like. For example, a purchase order business object might include only a product identifier (i.e. product ID) that refers to master data containing additional details about the referenced product.

### SUMMARY

In one aspect, a computer-implemented method includes accessing first operational data produced during completion of a first instance of at least one of a first business activity and a second business activity of an organization. The first and the second business activity are modeled using master data having at least one master data attribute in common with the first business activity. The master data attribute is derived based on at least the first operational data, and a second instance of the first business activity is modeled using the derived master data attribute.

In some variations one or more of the following can optionally be included. The derived master data attribute can include at least one of a master data value and a master data structure. The derived master data attribute can include at least one of a bill of operations and a bill of materials, and the deriving of the master data attribute can include refining a first version of the master data attribute used in modeling of the first instance to create a second version of the master data attribute for use in modeling of the second instance. The deriving of the master data attribute can be further based on a plurality of additional operational data, and the deriving can further include applying a statistical analysis method to the first operational data and the plurality of additional operational data.

The business activity can be modeled using at least one of a business process, a business scenario, and a business object. The at least one of the business process, the business scenario, and the business object can include the master data attribute. The first operational data and second operational data produced during completion of the second instance of the first business activity can be stored. At least the first operational data and the second operational data can be retrieved prior to execution of a third instance of the first business activity for use in re-deriving the master data attribute based on at least the first operational data and the second operational data so that the third instance of the first business activity can be modeled using the re-derived master data attribute.

Articles are also described that comprise a tangibly embodied machine-readable medium operable to cause one or more machines (e.g., computers, etc.) to result in operations described herein. Similarly, computer systems are also described that may include a processor and a memory coupled to the processor. The memory may include one or more programs that cause the processor to perform one or more of the operations described herein.

Various implementations of the subject matter described herein can provide one or more of the following and/or other advantages. For example the effort required for master data maintenance can be significantly reduced. The accuracy and representativeness of planned values or predictions of business process outcomes that are based on master data can also be improved. Furthermore, human interactions with an ERP or comparable system can be altered such that master data updates need not be maintained and entered prospectively. Rather, a master data value can be based on actual outcomes of business processes and progressively improved as additional operational data are available to better inform an expectation or range of expectations for an appropriate master data value. For example, a first instance of a document or other business object of a specific type (i.e., the first production order for a material) can be created directly without the use of master data. Each successive instance of that same type of document or business object can be based on master data values that are derived based on previously created document or business object instances using the same master data. With the creation of each additional document or business object, the available data upon which master data values can be based grows and the expectation value or values for the involved master data can be successively more accurate. Such an approach can effectively create a self-learning system.

It should be noted that, while the descriptions of specific implementations of the current subject matter may discuss delivery of enterprise resource planning software to one or more organizations, the current subject matter is applicable to other types of software and data services access as well. These examples are not meant to be limiting unless explicitly so stated in the foregoing description. The scope of the subject matter claimed below therefore should not be limited except by the actual language of the claims.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a process flow diagram illustrating aspects of a method;

FIG. 2 is a system diagram showing features of a system and

FIG. 3 is a data flow diagram illustrating features of modeling of master data attributes.

When practical, similar reference numbers denote similar structures, features, or elements.

### DETAILED DESCRIPTION

Master data are often used by several functional groups across an organization and can be stored in different data systems. While master data generally experience relatively infrequent changes in their values over time, their values are not generally permanent. Certain master data value changes, such as for example a change of a customer's address, changes in pricing structures of one or more products, etc., can be readily identified when they occur, and corresponding master data can be easily updated to reflect such changes.

Other master data are those that control processes, such as for example a lead time between receiving a request or an order for a product and the actual release or delivery of that product. Proper values of such master data can depend on a number of factors and are unlikely to be readily ascertained and/or maintained. Changes to master data representing less readily ascertained conditions related to business processes, etc. are not as easily kept up-to-date. Determining and maintaining appropriate values of such master data attributes can be difficult without extensive experience and knowledge of specific business processes. In one example, a production or replenishment time required to create an instance of a product can change due to a change in a supplier for a part or due to a change in delivery time for a part from a same supplier, perhaps due to the supplier moving its factory or distribution center. While master data reflecting the identity of the supplier and/or the location of a supplier's distribution center can be readily updated without requiring substantial knowledge about underlying business processes, the effects of such changes on product production or replenishment times can be much more difficult to determine or even to reasonably estimate.

To address these and potentially other issues with currently available solutions, one or more implementations of the current subject matter provide methods, systems, articles of manufacture, and the like that employ operational actual data (i.e., historical information regarding execution of business processes and the like) as a basis for determining values or structures of master data that are more properly representative of factors that impact performance of the underlying business processes. In some implementations, maintenance of operational data in one or more in-memory databases can enable real time analysis of high volume datasets. Alternatively, in instances where a real time analysis of historical data is either less practical or impractical due to performance issues (e.g., because the historical data are not available in a high performance in-memory data base), analysis of the historical data can be performed periodically, for example in batch mode during times when processor loads on a system architecture are low. If real time analysis is possible, the master data object instance can be updated whenever a new operational data object instance has been created or updated (e.g. using a “push” approach). Alternatively, the analysis can be performed when the next operational instance of the master data object (e.g. using a “pull” approach). In the latter case it is not necessary to persist the data in a master data object instance. However, the data can be directly persisted in the operational data object instance.

The master data values or structures obtained from such an analysis can be stored in master data objects or the like for retrieval during execution of business processes that depend upon them. Non-limiting examples of master data types whose values and/or structures can be ascertained using one or more features of the current subject matter can include delivery times, safety margins for inventory stocking, stock, goods receipt processing time, duration of operations, set-up times, material consumption, scrap ratios, and the like. Nearly any data value or data structure that is used in instances of multiple business objects and/or business processes can be amenable to use with the current subject matter.

In an alternative implementation, the term “master data” need not refer to a t

In one implementation, the current subject matter can be used to identify and/or maintain up-to-date physical master data attributes, such as for example times, quantities, values, and the like that are integral to business processes of an organization. In contrast to previously available approaches in which master data values may be determined based on human knowledge and experience, for example by a key user who has relevant knowledge of the processes, conditions, factors, and the like that can impact the business process, operational data values related to actual instances of execution of the business process can be evaluated to determine appropriate values for the relevant master data. As the business process is repeated, additional operational data based on each completed instance of the business process become available for analysis that can improve upon an initial manually entered estimate or default value or a value for the master data calculated on previously available operational data. In this manner, master data values related to a business process can be based on real world data and can be continuously or periodically updated as changes to real world factors or conditions result in changes in the operational data for successive instances of execution of the business process.

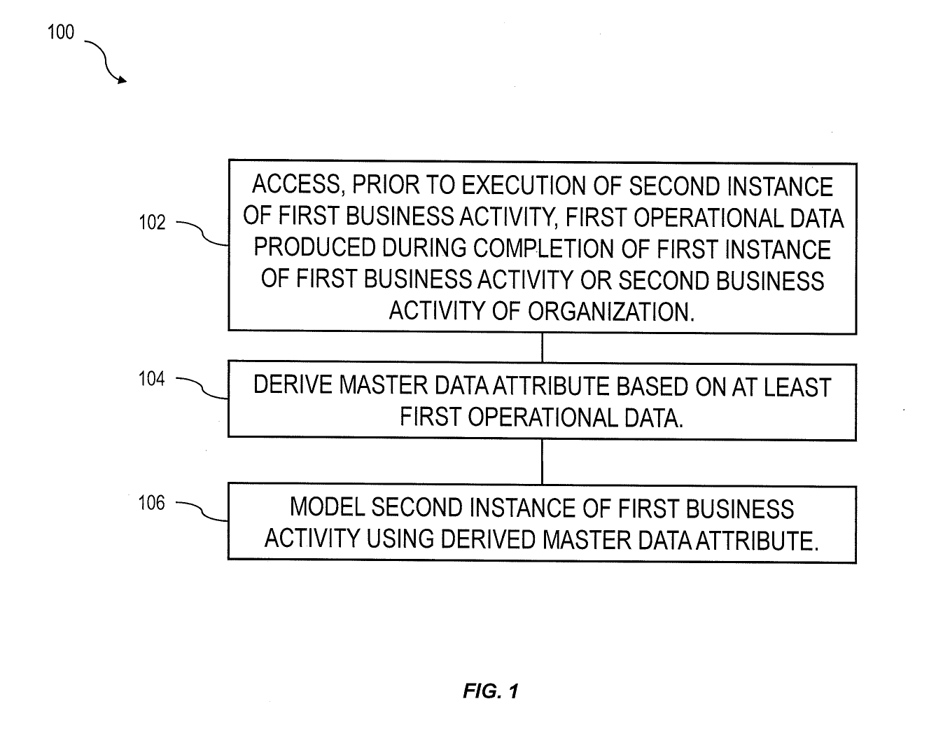

FIG. 1 shows a flow chart 100 illustrating features consistent with one or more implementations of the current subject matter. At 102, first operational data produced during completion of a first instance of a first business activity or a second business activity of an organization are stored in a data storage device. The first or the second business activity are modeled using master data having at least one master data attribute in common with the first business activity. At 104, at least the first operational data are retrieved from the data storage device prior to execution of a second instance of the first business activity. The master data attribute is derived at 106 based on at least the first operational data, and at 110 the second instance of the first business activity is modeled using the derived master data attribute.

In one illustrative example of the current subject matter, a delivery time for a component material or part used in the production of a organization's product can be supplier and/or material specific. One or more master data values can represent an expected delivery time of a unit of the component material or part, and this master data value can be used for planning of material requirements (i.e., a time period within which a needed material or part can be replenished), for providing a projected delivery time to a customer, or the like. The first time that a business process involving a master data instance is executed, a manually entered or other default value for the delivery time may be used.

However, if one or more deliveries of the component material or part, or optionally some other part or material, have been previously received from the supplier, actual delivery times that occurred in the previous delivery instances can be analyzed to determine an appropriate master data value to use for calculations related to current or future instances of deliveries from that supplier.

One or more approaches can be applied in the analysis of operational data to obtain updated master data values. For example, an average of the master data values obtained from all or, alternatively, operational data from a subset of previous instances of one or more business processes can be used to determine an appropriate master data value for use in a current instance of the business process. If operational data obtained for a subset of previous instances of business processes are used, one or more algorithms can be employed to determine which operational data to consider and what weights to assign to operational data from each previous instance. For example, operational data from previous instances of one or more business processes can be used only if those previous instances occurred within a threshold period of time prior to the current instance of the business process. Alternatively, operational data from previous instances of the one or more business processes can be weighted based on how long in the past the previous instance occurred. The analysis can also include additional factor analysis, to correct for the effects of features of one or more of the previous instances that might impact the master data obtained from the operational data related to the previous instances. Such features can include time (i.e. time of day, day of the week, time of year, holidays, seasons, etc.), weather, a supplier's identity and/or ship-from location, whether a particular instance of the business process was exceptional or otherwise might include non-typical values for the resulting operational data, and the like.

In some implementations, operational data from older instances of a business process can be given a lower weight than operational data from more recent instances. One or more statistical methods can be used to calculate confidence intervals for the predicted master data values based on operational data from previous instances of one or more business processes. In some cases it may not be possible to know initially which factors influence the master data attribute (e.g. the lead time) and/or the nature of that influence. In a traditional master data approach, it is generally necessary to have a master data object that defines the form of the master data. In such cases, it is possible to manage only those factors that are provided by the master data object model. For example, if master data object model does not include fields or other data structure in which to maintain ship-from specific delivery times, it is not possible to include such values in an analysis. The current subject matter enables a real time analysis to be performed concurrently with the information being needed (e.g. in an information pull) without the persisting information in a master data object. This approach can enable full flexibility to consider and analyze any factor that is identified by the statistical analysis.

Structures of master data can also be determined using one or more of the features described herein. For example, the production process for a product can typically be described with a bill of operations (BoO) defining the necessary operations and resources and a bill of material (BoM) defining the expected material consumption. The combination of a BoO and BoM can be called production plan. Such production plans are typically predefined as master data before the production of a first unit begins. Production orders for each unit of the product are then created based on that master data. The current subject matter provides an advantageous approach to deriving a BoO and/or a BoM from the actual operational data of completed production orders. This feature of the current subject matter is not limited to production processes. Any business process that would ordinarily be designed with master data that are assigned predicted values and structures for a first instance of the business process can be treated similarly. A first instance of a business process can be executed using predicted, pre-assigned values and structures, for example, based on input from a user with operational expertise related to the business process. Operational data collected from a first instance of the business process can be analyzed to determine appropriate master data values and structures to be used in a subsequent instance of the business process. As additional instances of the business process are completed, each additional set of instance-specific operational data can be added to a data set that is analyzed to further refine the existing master data values and structures as needed.

Master data structures can be derived, for example by simply performing a first instance of the business process without using predicted structures or values for the master data. The resulting operational data resulting from that performed first instance can be used to predict both appropriate values and appropriate structures for master data related to later executions of the business process.

As an example, a bill of operations (for example listing materials and operation steps required to perform a business process) can be derived based on observation and analysis of operational data for a first instance of the business process. There is no need to define how to complete the business process before the first instance is executed. In effect, the actions required in executing the first instance of the business process can inform the appropriate values and structures for master data to predict and plan for future instances of the business process. In this manner, employees or other entities with direct operational knowledge of the key details of a business process directly influence the creation of a definition of the business process. Such an approach can be beneficial as these employees or other entities can effectively “figure out” a best practice without such practices being imposed externally, for example by a business process designer who might not have the same level of knowledge of key operational details. Furthermore, as operational data relating to execution of successive instances of the business process become available, the master data values and structures relating to the business process are successively further refined based on what is actually happening in the execution of the business process. Data can be analyzed statistically. For example, a histogram of operational values resulting from each instance of the business process can be produced to allow optimization.

In another example of the current subject matter, operational data can be monitored to analyze processes to identify unexpected influences between variables or factors on the success of the business process. For example, if use of a first machine is detected to result in a higher frequency of production of out of specification products or components that use of a second machine, such unexpected results can be detected based on monitoring of the operational data resulting from each executed instance of the business process. Master data values applied to the business process can be selected based on whether a factor is present that has been previously identified as leading to outlier results.

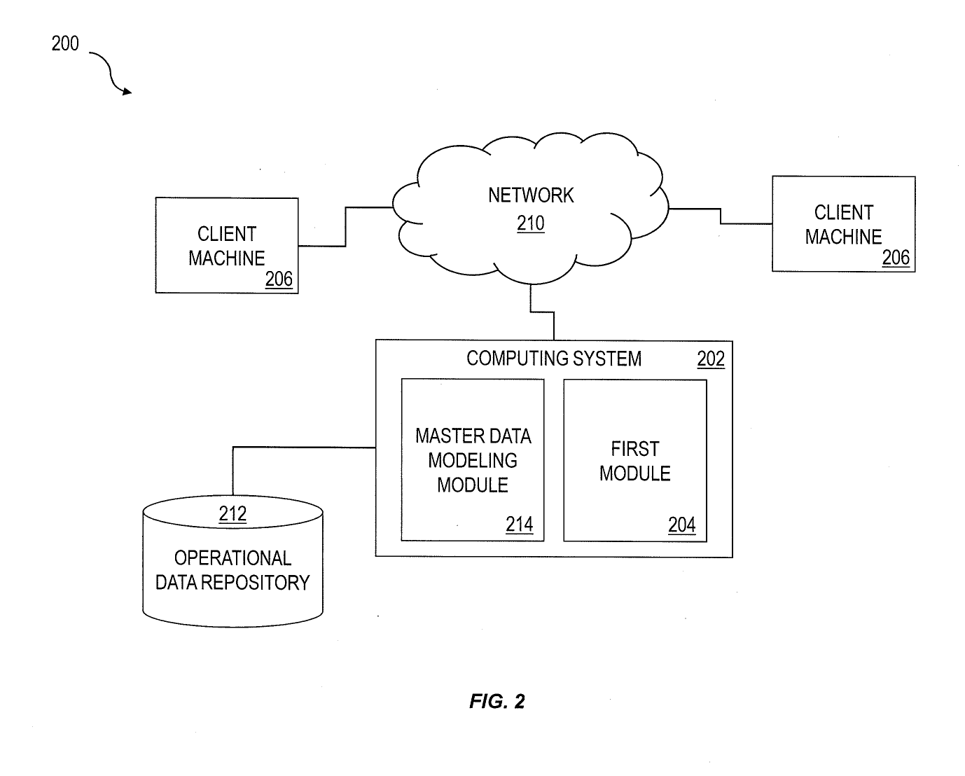

FIG. 2 shows an example of a system 200 consistent with the current subject matter. A computing system 202 that can include one or more programmable processors, which can be collocated, linked over one or more networks, etc., can execute one or more first modules 204 that provide one or more ERP or other software application functions accessible to local users as well as remote users accessing the computing system 202 from one or more client machines 206 over a network connection 210. Execution of one or more modeled business activities, which can include the use of business processes, business scenarios, business objects, or the like, can result in generation of operational data that can be collected and retained or stored in an operational data store 212, which can optionally be a database that is persisted on disk, in flash memory, etc. or an in-memory database. The collecting and retaining or storing of the operational data can optionally be performed by a master data modeling module 214. The master data modeling module can access operational data from the operational data store 212 prior to modeling a business activity having at least some master data attributes in common with previously completed business activity instances whose operational data are stored in the operational data store 212. Based on these retrieved operational data, the master data modeling module 214 can derive master data attributes to be used in modeling a current or future instance of the business activity.

In some implementations, the term “master data” can refer both either master data that are retained in a storage device for use in populating a later-required instance of a business object or to attributes that are derived in real time to populate data values that fit the previously defined features of master data but that are not necessarily ever stored as “master data” per se.

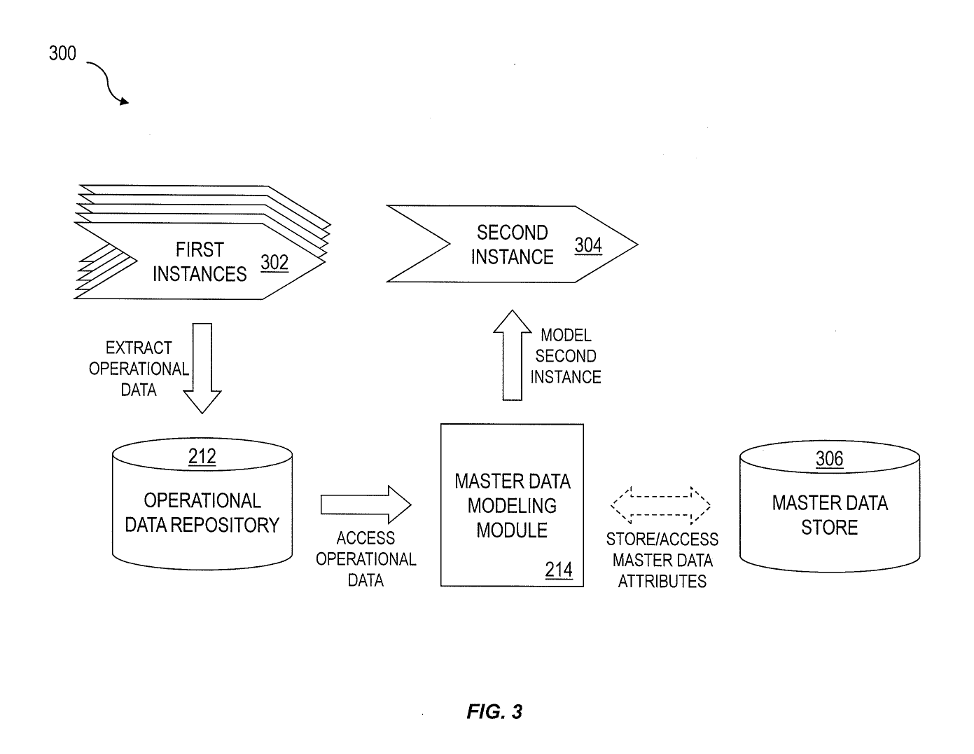

FIG. 3 shows a diagram 300 illustrating features consistent with implementations of the current subject matter. One or more first instance 302 of one or more business activities of an organization can be executed. During or subsequent to execution, one or more operational data values or the like can be extracted to or otherwise retained in an operational data store 212. To model a second instance 304 of a business process, a master data modeling module 214 can access the operational data from the operational data store 212. The master data modeling module 214 can generate master data attributes based on statistical analysis, etc. of the accessed operational data for use in the modeling of the second instance 304. The generated master data attributes can either be created in real time as they are needed for modeling of the second instance 304 or optionally stored in a master data store 306 for use in modeling later instances of a business activity. The stored master data attributes in the master data store can also optionally be accessed and used in conjunction with the operational data to derive revised (e.g. more current) versions of the master data attributes for use in modeling subsequent instances of the business activity or other business activities that make use of similar master data attributes.

The subject matter described herein can be embodied in systems, apparatus, methods, and/or articles depending on the desired configuration. In particular, various implementations of the subject matter described herein can be realized in digital electronic circuitry, integrated circuitry, specially designed application specific integrated circuits (ASICs), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. A client and server are generally, but not exclusively, remote from each other and typically interact through a communication network, although the components of the system can be interconnected by any form or medium of digital data communication. Examples of communication networks include, but are not limited to, a local area network (“LAN”), a wide area network (“WAN”), and the Internet. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer program product comprising a machine-readable medium storing instructions that, when executed by at least one programmable processor, cause the at least one programmable processor to perform operations comprising:
accessing, prior to execution of a second instance of a first business activity, first operational data produced during completion of a first instance of at least one of the first business activity and a second business activity of an organization, the first and the second business activity being modeled using master data having at least one master data attribute in common with the first business activity;
deriving the master data attribute based on at least the first operational data; and
modeling the second instance of the first business activity using the derived master data attribute.

2. A computer program product as in claim 1, wherein the derived master data attribute comprises at least one of a master data value and a master data structure.

3. A computer program product as in claim 1, wherein the derived master data attribute comprises at least one of a bill of operations and a bill of materials, and the deriving of the master data attribute comprises refining a first version of the master data attribute used in modeling of the first instance to create a second version of the master data attribute for use in modeling of the second instance.

4. A computer program product as in claim 1, wherein the deriving of the master data attribute is further based on a plurality of additional operational data, and the deriving further comprises applying a statistical analysis method to the first operational data and the plurality of additional operational data.

5. A computer program product as in claim 1, wherein the business activity is modeled using at least one of a business process, a business scenario, and a business object, the at least one of the business process, the business scenario, and the business object comprising the master data attribute.

6. A computer program product as in claim 1, wherein the operations further comprise:
storing, in a data storage device, the first operational data and second operational data produced during completion of the second instance of the first business activity;
retrieving at least the first operational data and the second operational data from the data storage device prior to execution of a third instance of the first business activity;
re-deriving the master data attribute based on at least the first operational data and the second operational data; and
modeling the third instance of the first business activity using the re-derived master data attribute.

7. A system comprising:
at least one programmable processor; and
a machine-readable medium storing instructions that, when executed by the at least one programmable processor, cause the at least one programmable processor to perform operations comprising:
accessing, prior to execution of a second instance of a first business activity, first operational data produced during completion of a first instance of at least one of the first business activity and a second business activity of an organization, the first and the second business activity being modeled using master data having at least one master data attribute in common with the first business activity;
deriving the master data attribute based on at least the first operational data; and
modeling the second instance of the first business activity using the derived master data attribute.

8. A system as in claim 7, wherein the derived master data attribute comprises at least one of a master data value and a master data structure.

9. A system as in claim 7, wherein the derived master data attribute comprises at least one of a bill of operations and a bill of materials, and the deriving of the master data attribute comprises refining a first version of the master data attribute used in modeling of the first instance to create a second version of the master data attribute for use in modeling of the second instance.

10. A system as in claim 7, wherein the deriving of the master data attribute is further based on a plurality of additional operational data, and the deriving further comprises applying a statistical analysis method to the first operational data and the plurality of additional operational data.

11. A system as in claim 7, wherein the business activity is modeled using at least one of a business process, a business scenario, and a business object, the at least one of the business process, the business scenario, and the business object comprising the master data attribute.

12. A system as in claim 7, wherein the operations further comprise:
storing, in a data storage device, the first operational data and second operational data produced during completion of the second instance of the first business activity;
retrieving at least the first operational data and the second operational data from the data storage device prior to execution of a third instance of the first business activity;
re-deriving the master data attribute based on at least the first operational data and the second operational data; and
modeling the third instance of the first business activity using the re-derived master data attribute.

13. A computer-implemented method comprising:
accessing, prior to execution of a second instance of a first business activity, first operational data produced during completion of a first instance of at least one of the first business activity and a second business activity of an organization, the first and the second business activity being modeled using master data having at least one master data attribute in common with the first business activity;
deriving the master data attribute based on at least the first operational data; and
modeling the second instance of the first business activity using the derived master data attribute.

14. A computer-implemented method as in claim 13, wherein the derived master data attribute comprises at least one of a master data value and a master data structure.

15. A computer-implemented method as in claim 13, wherein the derived master data attribute comprises at least one of a bill of operations and a bill of materials, and the deriving of the master data attribute comprises refining a first version of the master data attribute used in modeling of the first instance to create a second version of the master data attribute for use in modeling of the second instance.

16. A computer-implemented method as in claim 13, wherein the deriving of the master data attribute is further based on a plurality of additional operational data, and the deriving further comprises applying a statistical analysis method to the first operational data and the plurality of additional operational data.

17. A computer-implemented method as in claim 13, wherein the business activity is modeled using at least one of a business process, a business scenario, and a business object, the at least one of the business process, the business scenario, and the business object comprising the master data attribute.

18. A computer-implemented method as in claim 13, further comprising:
storing, in a data storage device, the first operational data and second operational data produced during completion of the second instance of the first business activity;
retrieving at least the first operational data and the second operational data from the data storage device prior to execution of a third instance of the first business activity;
re-deriving the master data attribute based on at least the first operational data and the second operational data; and
modeling the third instance of the first business activity using the re-derived master data attribute.

19. A computer-implemented method as in claim 13, wherein the at least one of the accessing, the deriving, and the modeling are performed by at least one programmable processor.
